(19) United States
(12) Patent Application Publication
(10) Pub. No.: US 2005/0140793 A1
(43) Pub. Date: Jun. 30, 2005

(54) Camera having shake compensation function

(75) Inventors: Kazuhiko Kojima, Kawachinagano-shi (JP); Tougo Teramoto, Wakayama-shi (JP); Hisanori Itoh, Osaka-shi (JP); Yoshito Konishi, Sakai-shi (JP); Atsushi Yamanishi, Matsubara-shi (JP); Satoshi Yokota, Toyonaka-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/967,621

(22) Filed: Oct. 18, 2004

(30) Foreign Application Priority Data
Dec. 26, 2003 (JP) 2003-432969

(51) Int. Cl. H04N 5/228

(52) U.S. Cl. 348/208.99

(57) ABSTRACT

A camera body to which one of a plurality of interchangeable lenses is selectively attached is provided with: a shake detector 31; a shake compensation mechanism 32; and a controller 30 that compensates for the camera shake by driving the shake compensation mechanism based on the output from the shake detector. The controller 30 has a detector and a selector. The detector communicates with the attached interchangeable lens 20 and determines whether the interchangeable lens 20 itself has a shake compensation mechanism or not. The selector selects, when the detector determines that the interchangeable lens 20 has a shake compensation mechanism, both or one of the shake compensation mechanism of the camera body 10 and the shake compensation mechanism of the interchangeable lens 20 according to a predetermined condition as a compensation mechanism to be used for camera shake compensation.

This application is based on application No. 2003-432969 filed in Japan, the content of which is hereby incorporated by reference.

### BACKGROUND OF THE INVENTION

1. Field of the Invention

The present invention relates to a camera having a shake compensation function. Moreover, the present invention relates to a camera used with one of a plurality of interchangeable lenses being selectively attached to a camera body having a shake compensation function.

2. Description of the Related Art

There are cases where a so-called camera shake occurs in which the camera moves due to a shake of the hands holding the camera at the time of exposure. Cameras have previously been known that have a shake compensation function to compensate for the image movement due to the camera shake. For example, a camera is known in which a compensation lens unit and a shift mechanism that drives the lens unit are provided in the lens barrel of the interchangeable lens selectively attached to the camera body and when a camera shake occurs, the camera shake is compensated for by driving the compensation lens unit so that the image movement due to the camera shake is compensated for.

Moreover, a digital camera is known in which when a camera shake occurs, the camera shake is compensated for by moving the image sensor in the camera body so that the image movement due to the camera shake is compensated for.

Moreover, a video camera is known in which when a camera shake occurs, the camera shake is compensated for by varying the range of the charge readout from the image sensor so that the image movement on the image sensor due to the camera shake is compensated for.

In all of these conventional examples, the number of systems provided for camera shake compensation is only one. Even if the degree of camera shake is the same, when the focal length of the lens is increased, the movement amount and movement speed of the optical system (or the image sensor) necessary for compensation of the camera shake are increased. Moreover, it is necessary to provide a large image sensor for the actual image signal reading out area.

Thus, compensation by one shake compensation system increases the size of the shake compensation system itself, which leads to an increase in the size of the camera body or the lens barrel.

### SUMMARY OF THE INVENTION

Accordingly, an object of the present invention is to provide a camera capable of compensating for a larger camera shake without any increase in the size of the camera body or the lens barrel.

A first aspect of the present invention provides a camera body to which one of a plurality of interchangeable lenses is selectively attachable, the camera body comprising: a shake detector that detects a camera shake with respect to the subject; a shake compensator that functions so as to cancel an image movement caused by the shake; and a controller that compensates for the camera shake by causing the shake compensator to function based on the output from the shake detector.

The controller comprises: a detector that communicates with the attached interchangeable lens and determines whether the interchangeable lens itself has a shake compensator or not; and a selector that selects, when the detector determines that the interchangeable lens has a shake compensator, both or one of the shake compensator of the camera body and the shake compensator of the interchangeable lens according to a predetermined condition in order to cause the selected shake compensator to function.

The detector and the selector may be realized by software processing described as a program.

Another aspect of the present invention provides a camera system comprising: a plurality of interchangeable lenses including at least one interchangeable lens having a shake compensator; and the above-described camera body.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1A is a front view of a camera according to an embodiment of the present invention;

FIG. 1B is a rear view of the camera;

FIG. 2 is a front view showing a condition where an interchangeable lens is detached from the camera;

FIG. 3 is a side view of the camera;

FIG. 4 is a block diagram showing the mechanical structure and function of the camera;

FIG. 5 is a schematic perspective view showing an example of a shake compensation actuator of the camera body;

FIG. 6 is a flowchart for explaining a first example of the operation of the camera;

FIG. 7 is a flowchart for explaining the continuation of the operation example of FIG. 6;

FIG. 8 is a flowchart for explaining a second example of the operation of the camera;

FIG. 9 is a flowchart for explaining a third example of the operation of the camera;

FIG. 10 is a flowchart for explaining a fourth example of the operation of the camera;

FIG. 11 is a graph explaining a relationship between the camera shake amount and the compensation amount;

FIG. 12 is a graph explaining a relationship between the camera shake amount and the compensation amount;

FIG. 13 is a graph explaining a relationship between the camera shake amount and the compensation amount;

FIG. 14 is a graph explaining a relationship between the camera shake speed and the compensation amount;

FIG. 15 is a graph explaining a relationship between the camera shake speed and the compensation amount;

FIG. 16 is a graph explaining a relationship between the camera shake speed and the compensation amount;

FIG. 17 is a graph explaining compensation characteristics;

FIG. 18 is a graph explaining compensation characteristics; and

FIGS. 19A to 19C show tables of preferred combinations with respect to which compensation mechanism is assigned the camera shake compensation in the horizontal direction or the vertical direction according to the types of the shake compensation mechanisms provided in the camera body and the interchangeable lens.

### DETAILED DESCRIPTION OF THE PREFERRED EMBODIMENTS

<<Camera Structure>>

An embodiment of the present invention will be described in detail with reference to the attached drawings.

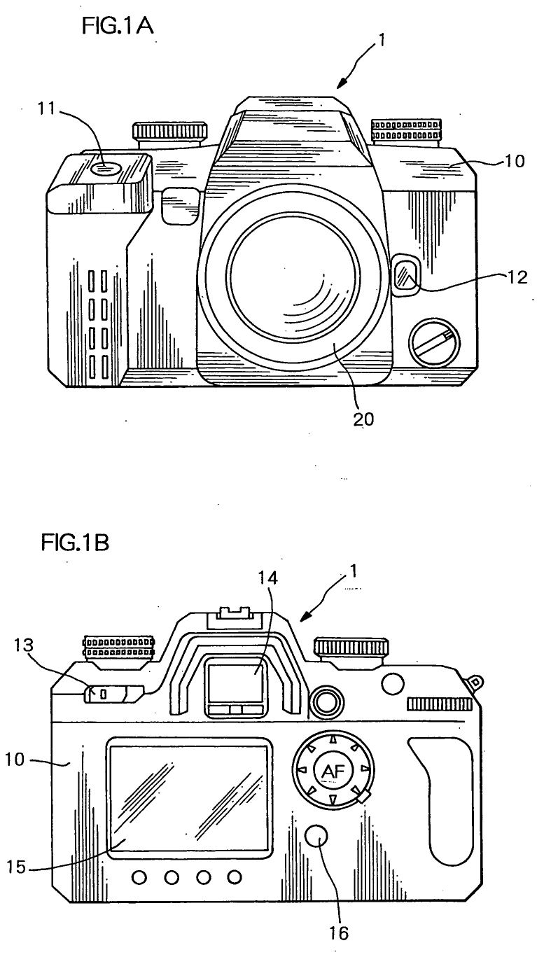

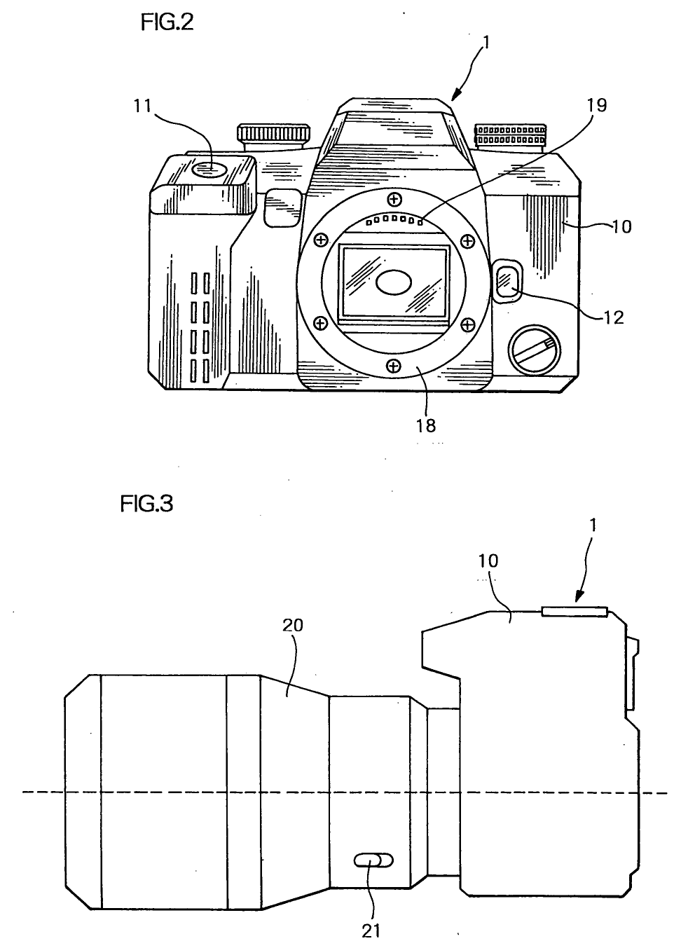

The camera 1 shown in FIGS. 1A to 3 is a digital camera in which one of a plurality of interchangeable lenses can be selectively attached to the camera body 10. FIGS. 1A and 3 show a condition where an interchangeable lens 20 is attached. The lens can be interchanged by operating a lens detachment button 12. FIG. 2 shows a condition where the lens is detached, and a connection terminal 19 for body-lens communication is provided inside an annular lens mount 18.

The camera body 10 has a shutter button 11 in an upper part of the front surface thereof and has a power switch 13, a finder window 14, an LCD 15 and a shake compensation button 16 on the rear surface thereof.

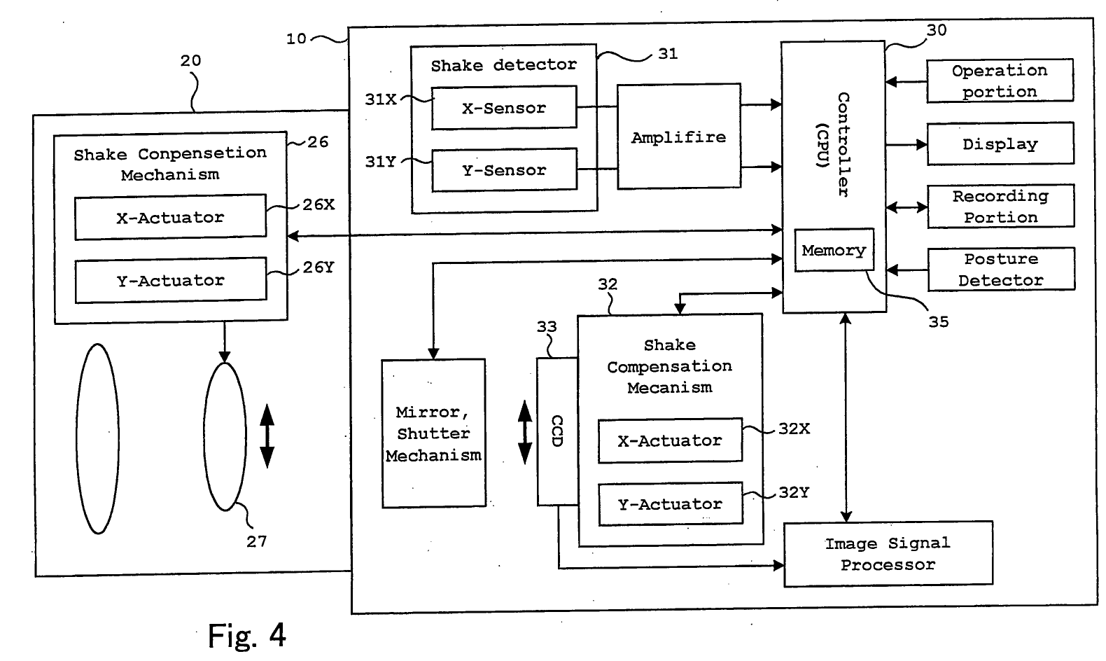

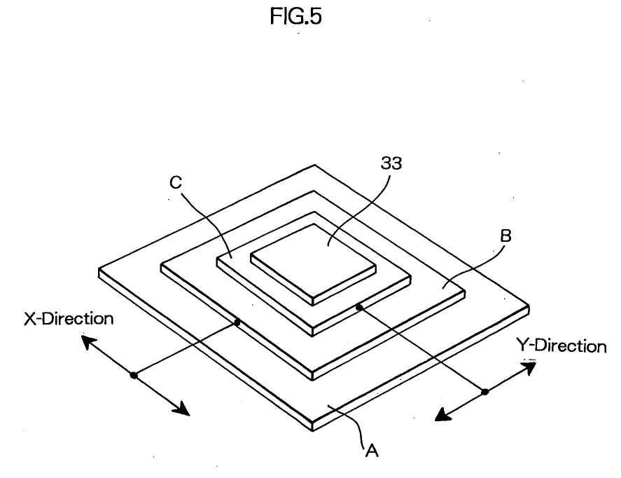

Now, the principal structure and function in the condition where the interchangeable lens 20 is attached will be described with reference to FIG. 4.

A shake detector 31 having two angular velocity sensors 31x and 31y is provided in the camera body 10. The angular velocity sensor 31x detects camera shake in the X direction (horizontal direction), whereas the angular velocity sensor 31y detects camera shake in the Y direction (vertical direction). The signals from the sensors 31x and 31y are amplified by an amplifier, and are then inputted to a controller 30 including a CPU.

The controller 30 calculates the necessary compensation amounts (the movement amount and the movement speed) for each of the X and Y directions based on the signals from the shake detector 31, and drives a mechanical shake compensation system, that is, a shake compensation mechanism 32 to drive the image sensor, specifically, a CCD 33, thereby compensating for the camera shake.

As mentioned later, the camera compensation mechanism 32 has an X-direction actuator 32x and a Y-direction actuator 32y.

A memory 35 in FIG. 4 comprises a ROM or a RAM holding various control programs and data.

The interchangeable lens 20 itself has a shake compensation mechanism 26, and has a compensation function on/off switch 21 in a side surface of the lens barrel.

Like the shake compensation mechanism 32 of the camera body 10, the shake compensation mechanism 26 in the lens barrel has an X-direction actuator 26x and a Y-direction actuator 26y, and drives a shake compensation optical system 27 according to an instruction from the controller 30 of the camera body 10.

That is, the controller 30 of the camera body 10 compensates for the camera shake by driving both or one of the “shake compensation mechanism 32 of the camera body 10” and the “shake compensation mechanism 26 of the interchangeable lens 20.” Whether both of the shake compensation mechanisms are used or one of the shake compensation mechanisms is used is determined according to a predetermined condition as mentioned later.

To the camera body 10, an interchangeable lens not having a shake compensation mechanism can be attached. The controller 30 communicates with the interchangeable lens 20 and determines whether the lens 20 has a shake compensation mechanism or not.

<<Shake Compensation Mechanism of the Camera Body>>

Now, the concrete structure of the shake compensation mechanism 32 that slides the CCD 33 in the camera body 10 will be briefly described with reference to FIG. 5.

A substrate A is immovably fixed in the camera body 10. A substrate B is placed on the substrate A, and is supported by non-illustrated guide mechanism so as to be slidable in the X direction on the substrate A. A drive mechanism (the X-direction actuator 32x) using a piezoelectric element is provided on the substrate A, and by coupling the driver of the drive mechanism to the substrate B, the sliding of the substrate B relative to the substrate A is realized.

A substrate C is placed on the substrate B, and is supported by non-illustrated guide mechanism so as to be slidable in the Y direction on the substrate B. A drive mechanism (the Y-direction actuator 32y) using a piezoelectric element is provided on the substrate B, and by coupling the driver of the drive mechanism to the substrate C, the sliding of the substrate C relative to the substrate B is realized.

The CCD 33 is fixed onto the substrate C. Therefore, by combining the slidings of the substrate B and the substrate. C, the CCD 33 can be slid relatively to the camera body 10 within one plane. In the present invention, however, the mechanism that slides the image sensor is not limited to a specific structure, and the structure described here is a mere example.

<<Shake Compensation Mechanism of the Lens Barrel>>

In the lens barrel, as shown in FIG. 4, camera shake compensation is made by sliding the optical system 27 by the compensation mechanism 26 including the X-direction actuator 26x and the Y-direction actuator 26y. This is also a mere example, and for example, a variable vertex compensation mechanism (not shown) may be adopted that is formed by sealing, by two transparent glass plates, both ends of a bellows filled with a transparent liquid such as silicon oil.

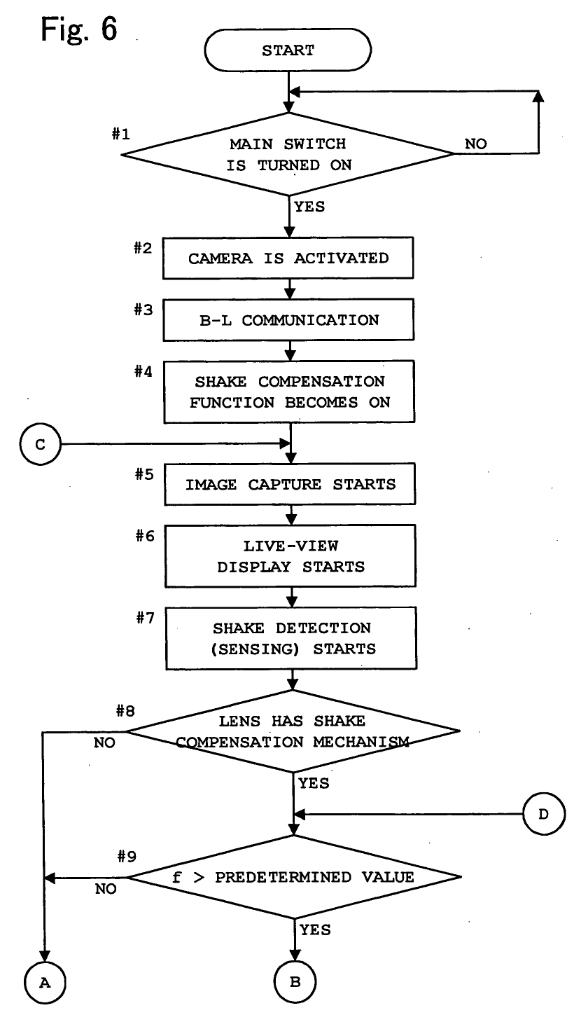

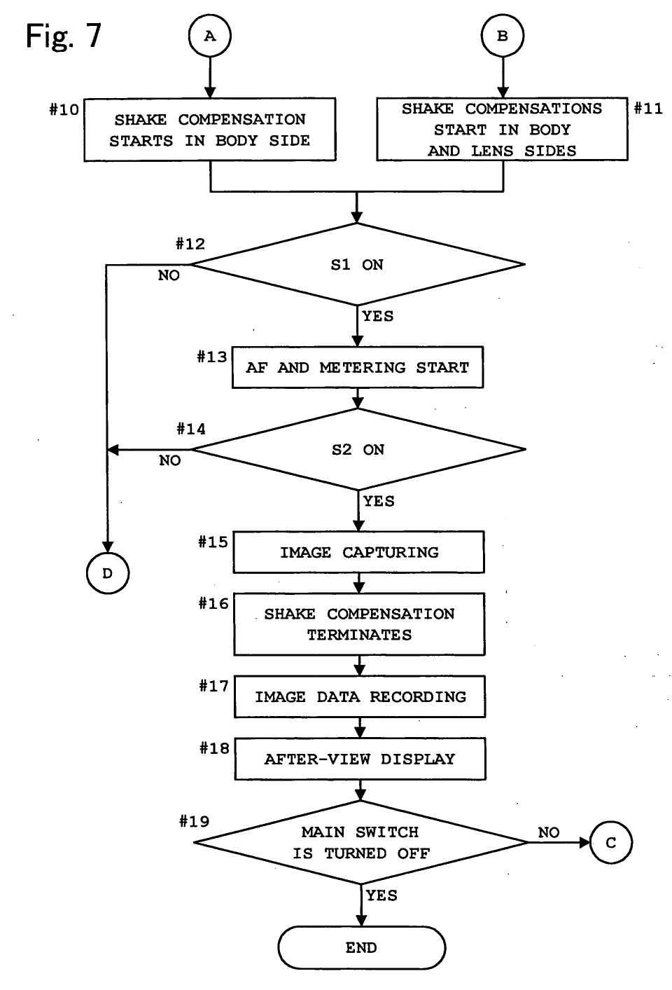

Next, an example of the operation of the above-described camera will be described with reference to the flowcharts of FIGS. 6 and 7. When the user turns on the power switch 13, the camera is activated, and the controller 30 performs BL communication, that is, body-lens communication (#1→#2→#3). In the BL communication, the controller 30 reads data in the ROM or RAM (both are not shown) in the lens barrel and uses the data as the camera control value. The BL communication is performed every time when a button such as the shutter button, the mode setting button or the lens interchange button is turned on as well as when the power switch is turned on.

When the user turns on the shake compensation button 16 (see FIG. 1B) of the camera body 10, image sensing is started, and a real-time image (called a live view image) is displayed on the LCD 15 on the rear surface of the camera and camera shake sensing is started (#4→#5→#6→#7) . At #7, to compensate for the camera shake, the controller 30 reads the output from the shake detector 31 in the camera body 10.

At #8, the controller 30 determines whether the interchangeable lens 20 attached to the camera body 10 has a shake compensation mechanism or not. This determination is made based on data stored in the ROM in each interchangeable lens 20.

When the interchangeable lens 20 does not have a shake compensation mechanism, only the shake compensation mechanism of the camera body 10 is selected, and shake compensation is started by use of the mechanism (#8→#10).

When the interchangeable lens 20 has a shake compensation mechanism, whether the focal length of the interchangeable lens exceeds a predetermined value or not is determined next (#8→#9). When the focal length of the interchangeable lens exceeds the predetermined value, the shake compensation mechanisms of the interchangeable lens 20 and the camera body 10 are both selected, and camera shake compensation is started by use of both of the mechanisms (#9→#11). When the focal length does not exceed the predetermined value, only the shake compensation mechanism of the camera body 10 is selected, and camera shake compensation is started by use of the mechanism (#9→#10).

In the shown example, when only one of these shake compensation mechanisms is selected (when the process proceeds from #9 to #10), the shake compensation mechanism of the camera body 10 is selected. However, the shake compensation mechanism of the interchangeable lens 20 may be selected in such a case. Which one of these compensators is selected is appropriately determined in consideration of the characteristics and the like of the actually adopted compensation mechanisms.

The reason why both of the shake compensation mechanisms are used when the focal length of the interchangeable lens exceeds the predetermined value is as follows: “When it is assumed that the camera shake amount is the same, the larger the focal length is, the larger the movement amount of the image sensor (or the compensation lens) necessary for compensating for the camera shake is, and to cope with this, both of the compensation mechanisms are used.

The specific value of the focal length serving as the criterion of the determination differs according to the characteristic of the actually adopted compensation mechanism of the camera body 10 or the interchangeable lens 20.

When the shutter button 11 is depressed halfway (S1 on), AF (automatic focusing) and metering for AE (automatic exposure) are performed (#12→#13). When the shutter button 11 is fully depressed (S2 on), image data is captured from the image sensor, and camera shake compensation is finished (#14→#15→#16). Then, the image data is recorded into the memory 35, and an image based on the recorded image data (this image is called an after view image) is displayed on the LCD on the rear surface of the camera (#17→#18). Thereafter, when the user turns off the power switch 13, the flow is ended, and when the user does not turn off the power switch 13, the process proceeds to #5 to repeat the above-described procedure (#19→#5).

When the shutter button 11 is not fully depressed at #14, since various situations are considered such that the user is waiting for a good moment to take a picture, that the user is changing the composition and that the user is changing the subject, the process returns to #9 to repeat the operation (#14→#9), and waits for the shutter button 11 to be fully depressed.

While the power can be forcibly turned off during this time in the actual operation and an operation to shift to the power saving state when the S1 off state is continued for not less than a predetermined time is added, these are omitted for the sake of simplification of the flowchart.

While which shake compensation mechanism is actuated is appropriately selected according to the value of the focal length in the above-described example, the selection of the shake compensation mechanism may be made based on a different condition. For example, since it is considered that the camera is not sufficiently firmly held when the user aims the camera and makes preparations for exposure (such as at the time of the sensing of the eye sensing switch and when the shutter button is half depressed), when the camera shake amount detected by the shake detector 31 at this time is larger than a predetermined value, both of the shake compensation mechanisms may be preselected.

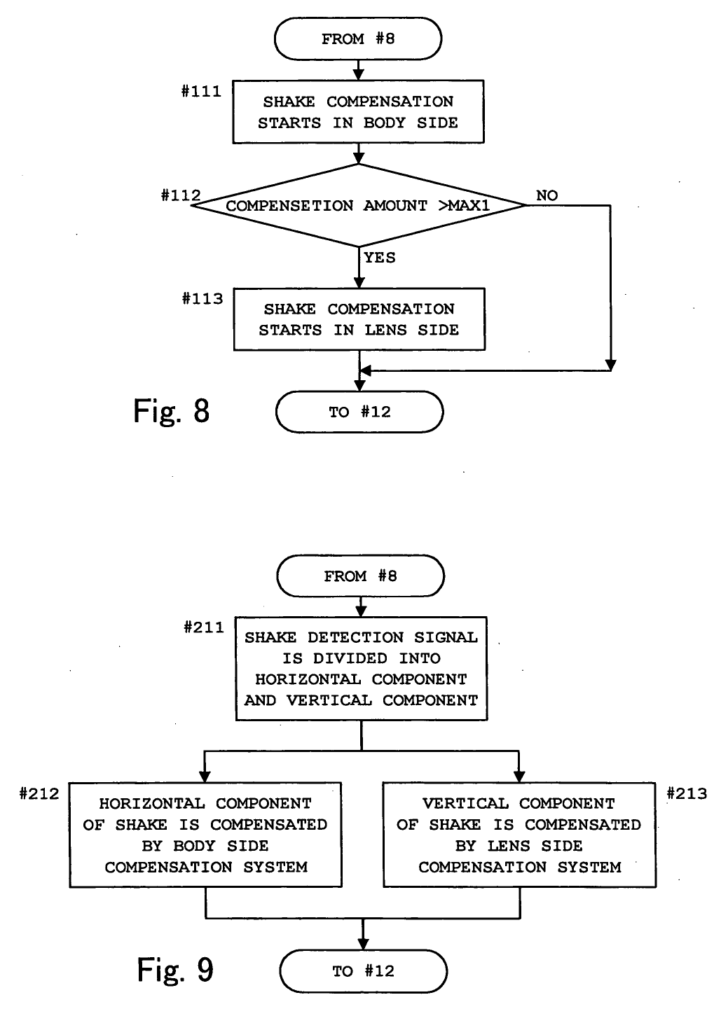

Next, another example of the flowchart will be described with reference to FIG. 8. While both of the shake compensation mechanisms are selected when the focal length exceeds the predetermined value in the procedure from #9 to #11 of the flowchart described with reference to FIGS. 6 and 7, the flowchart of FIG. 8 is a second example which is an alternative to this procedure.

While the shake compensation mechanism 32 of the camera body 10 compensates for the camera shake by sliding the CCD 33, the camera shake amount (the movement amount or movement speed of the subject) that can be compensated for by this mechanism is limited. This limit value is a known value specific to the mechanism.

In the example of FIG. 8, the camera shake amount (the movement distance or the movement speed) to be compensated for is obtained based on the output from the shake detector 31, and camera shake compensation is made by the compensation mechanism 32 of the camera body 10 at first. Then, when the camera shake amount to be compensated for is not more than the limit value, compensation is made successively by use of only the shake compensation mechanism 32 of the camera body 10.

When the amount to be compensated for exceeds the limit value, the lens side shake compensation mechanism 26 is additionally driven to compensate for the part beyond the limit value. By doing this, a large camera shake that cannot be completely compensated for by only the body side can be compensated for.

The example of FIG. 8 is an example using two shake compensation mechanisms in time series. However, this example includes a structure in which although the compensation mechanisms are used in time series, the time periods during which these compensation mechanisms are functioning overlap each other to some extent on the border.

In the shown example, when the camera shake amount is smaller than the limit value, only the body side shake compensation mechanism 32 is selected. However, only the shake compensation mechanism 26 of the interchangeable lens 20 may be selected. Which one of these compensation mechanisms is selected is appropriately determined in consideration of the characteristics of the actually adopted compensation mechanisms.

Next, another example of the flowchart will be described with reference to FIG. 9. The flowchart of FIG. 9 is a third example which is an alternative to the procedure from #9 to #11 of the flowcharts of FIGS. 5 and 6. While two shake compensation mechanisms are actuated in time series in the example of FIG. 8, in the example of FIG. 9, two shake compensation mechanisms are simultaneously actuated in parallel.

At #211, the output from the shake detector 31 is recognized being separated into a horizontal component and a vertical component. In actuality, as shown in FIG. 4, the two sensors 31x and 31y in the shake detector 31 output the camera shake of the horizontal component (X direction) and the camera shake of the vertical component (Y direction), respectively.

The camera shake in the horizontal direction is compensated for by moving the image sensor by the body side shake compensation mechanism 32 (#212). On the other hand, the camera shake in the vertical direction is compensated for by moving the optical system by the shake compensation mechanism 26 of the interchangeable lens 20 (#213).

Conversely to the above, it may be performed to compensate for the camera shake in the horizontal direction by moving the optical system on the lens side and compensate for the camera shake in the vertical direction by moving the image sensor on the camera side. Which of the body side and lens side compensation mechanisms is associated with the camera shake compensation in the horizontal direction or the camera shake compensation in the vertical direction may be appropriately determined from various conditions.

Now, an example of assignment in the vertical direction and the horizontal direction will be described.

For example, it is assumed that the compensation mechanism of the camera body 10 slides the image sensor upward and downward, and rightward and leftward (FIG. 5) and the lens side compensation mechanism is a variable vertex compensation mechanism (not shown).

In the slide-type compensation mechanism of the camera body 10, since it is necessary to raise or lower a physical structure against gravity, the load for compensating for the camera shake in the vertical direction is heavy. Therefore, for the camera shake compensation in the vertical direction, the variable vertex compensation mechanism on the lens side is used, and the shake compensation mechanism on the body side is assigned the camera shake compensation in the horizontal direction.

In this case, the position of the camera is detected (that is, whether the user holds the camera longitudinally or laterally is detected) based on the output shown in the sensor (position detector) shown in FIG. 4, and it is recognized that which of the X-direction signal and the Y-direction signal based on the angular velocity sensors indicates the vertical direction or the horizontal direction. By doing this, the shake compensation mechanism on the camera side can be always assigned the camera shake compensation in the horizontal direction irrespective of whether the camera is held longitudinally or laterally.

When the shake compensation system of the camera body 10 adopts a digital method or digital system, the shake compensation system is assigned the compensation of the camera shake in the vertical direction. The digital system in which the starting point of reading out of the image data taken by the CCD 33 is varied is a method based on the handling of the image data and is provided with no member that moves mechanically. The digital shake compensation system is assigned the camera shake compensation in the vertical direction because in the digital shake compensation system, it is unnecessary to raise or lower a physical structure against gravity and the load in that sense is absent.

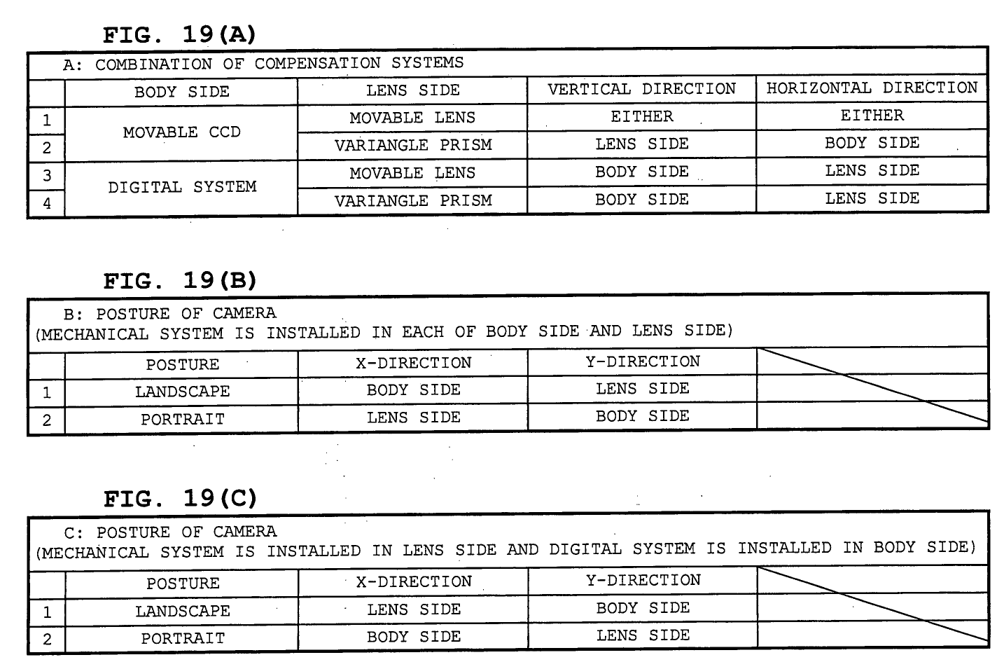

In FIG. 19A, preferred combinations are tabulated with respect to which of the compensation systems is assigned the camera shake compensation in the horizontal direction or the vertical direction according to the types of the shake compensation systems provided in the camera body 10 and the interchangeable lens 20.

In FIGS. 19B and 19C, the X direction corresponds to the direction of length of the exposure image plane, and the Y direction corresponds to the direction vertical thereto. Which of the X and Y directions is the vertical direction or the horizontal direction differs according to the position of the camera.

That is, when the camera is held laterally, the X direction corresponds to the horizontal direction and the Y direction corresponds to the vertical direction. Conversely, when the camera is held longitudinally, the X direction corresponds to the vertical direction and the Y direction corresponds to the horizontal direction.

FIG. 19B shows a case where a mechanical shake compensation system (the type that slides the image sensor or the optical system, or the variable vertex compensation mechanism) is provided in both of the camera body 10 and the interchangeable lens 20.

In this case, the shake compensation mechanism of the camera body 10 is always assigned the camera shake compensation in the horizontal direction. Since the compensation mechanism of the camera body 10 is typically larger in movement stroke and the load thereon increases if the camera shake compensation in the vertical direction is assigned thereto, to avoid this, the camera shake compensation in the horizontal direction is assigned thereto.

FIG. 19C shows a case where a digital shake compensation system is provided in the camera body 10 and a mechanical shake compensation system is provided in the interchangeable lens 20.

In this case, the shake compensation system of the camera body 10 is always assigned the camera shake compensation in the vertical direction. This is because in the digital shake compensation system, the load against gravity is absent for the compensation in the vertical direction as mentioned above.

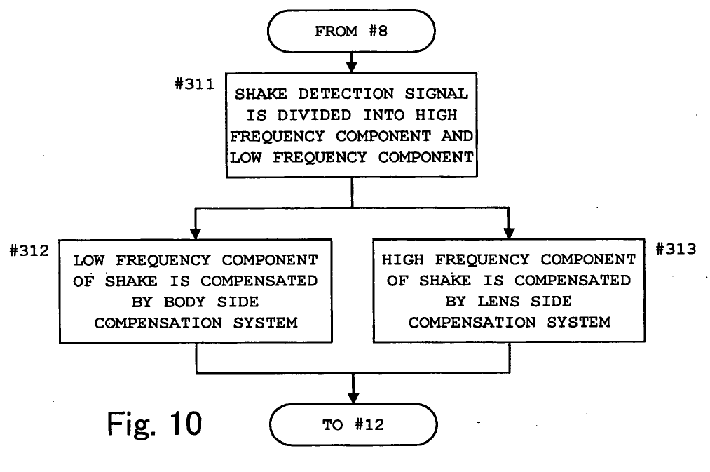

Next, another example of the flowchart will be described with reference to FIG. 10. The flowchart of FIG. 10 is a fourth example which is an alternative to the procedure from #9 to #11 of the flowcharts of FIGS. 5 and 6. In this case, two shake compensation mechanisms are simultaneously actuated in parallel like in the case of FIG. 9.

At #311, the output from the shake detector 31 is recognized being separated into a high-frequency component and a low-frequency component. In actuality, a low-pass filter and a high-pass filter are provided in the amplifier that amplifies the output, and each of the outputs of the X-direction component and the Y-direction component is separated into a high-frequency component and a low-frequency component. The controller 30 converts the inputted signals into camera shake compensation signals.

The camera shake of the low frequency is compensated for by moving the CCD 33 by the body side shake compensation mechanism 32 (#312). On the other hand, the camera shake of the high frequency is compensated for by moving the optical system 27 by the lens side compensation mechanism 26 (#313).

Conversely to the above, it may be performed to compensate for the camera shake of the low frequency by moving the optical system on the lens side and compensate for the camera shake of the high frequency by moving the image sensor on the body side. Which of the body side and lens side compensation mechanisms is associated with the camera shake compensation of the low frequency or the camera shake compensation of the high frequency may be appropriately determined from various conditions.

The workings of the above-described structure will be described.

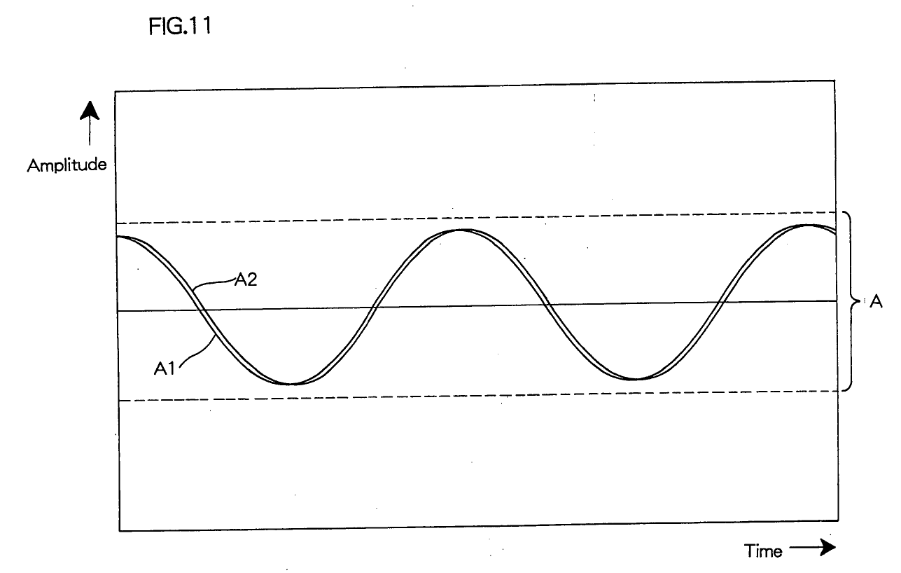

In FIG. 11, the region A surrounded by the broken lines indicates a range of amplitudes that can be compensated for by one shake compensation system. The wavy line A1 represents the amount of relative image movement due to a camera shake (that is, the distance requiring compensation). On the other hand, the wavy line A2 represents the amount compensated for by the shake compensation system.

The amplitudes of the wavy lines A1 and A2 are the same. That is, FIG. 11 indicates that “if the occurring camera shake is within the region A, the camera shake can be compensated for by one of the shake compensation systems.”

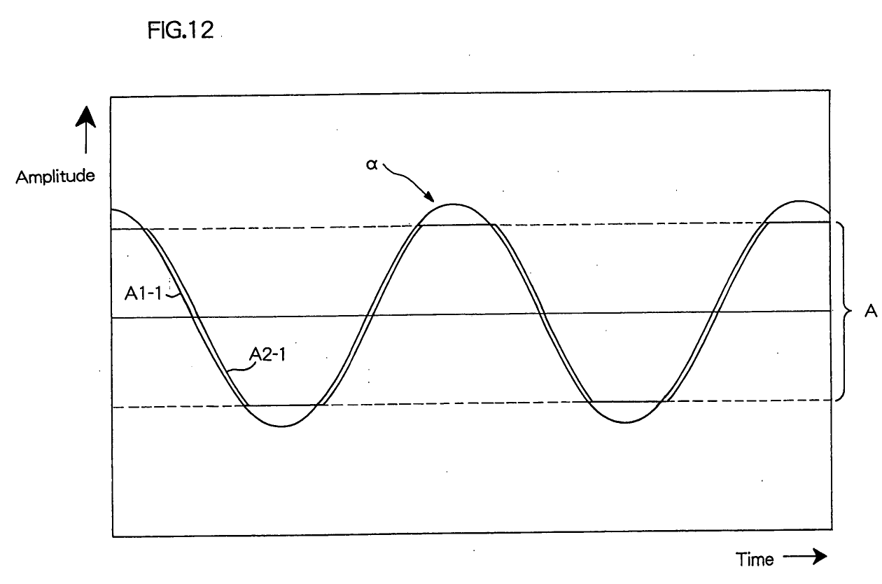

However, when the image movement amount A1-1 exceeds the region A as shown in FIG. 12, compensation cannot be completely made by one shake compensation system and the compensation amount A2-1 compensated for by the compensation system cannot completely follow the wavy line A1-1, so that a large camera shake corresponding to the vicinity of the peak (α) of the wavy line A1-1 cannot be compensated for.

That is, FIG. 12 explains that “when only one shake compensation system is provided, a camera shake larger than a predetermined amount cannot be compensated for.”

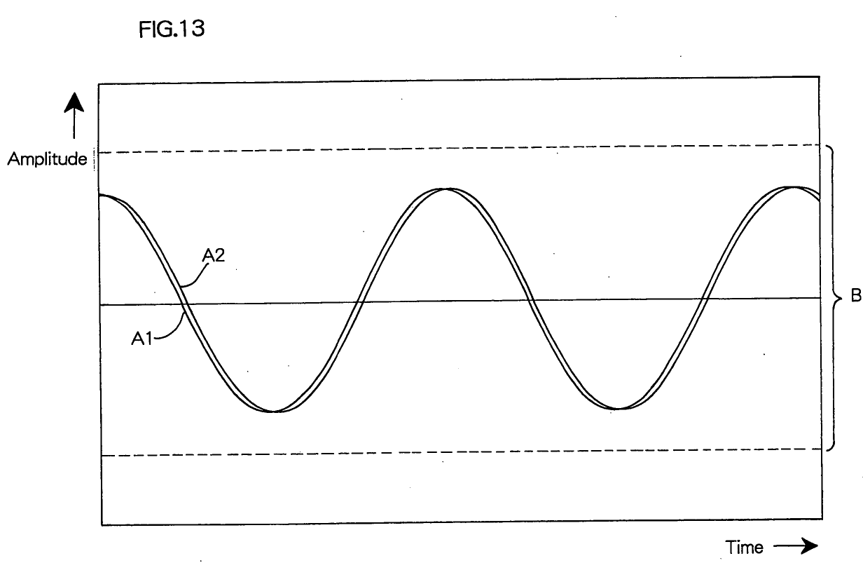

In FIG. 13, the region B surrounded by the broken lines indicates a range of amplitudes that can be compensated for by two shake compensation systems. The region B is larger than the region A of the case where the number of shake compensation mechanisms is one (FIG. 11).

That is, FIG. 13 explains that “when camera shake compensation is made by use of two shake compensation systems, a larger camera shake can be compensated for than in the conventional example of FIG. 12.”

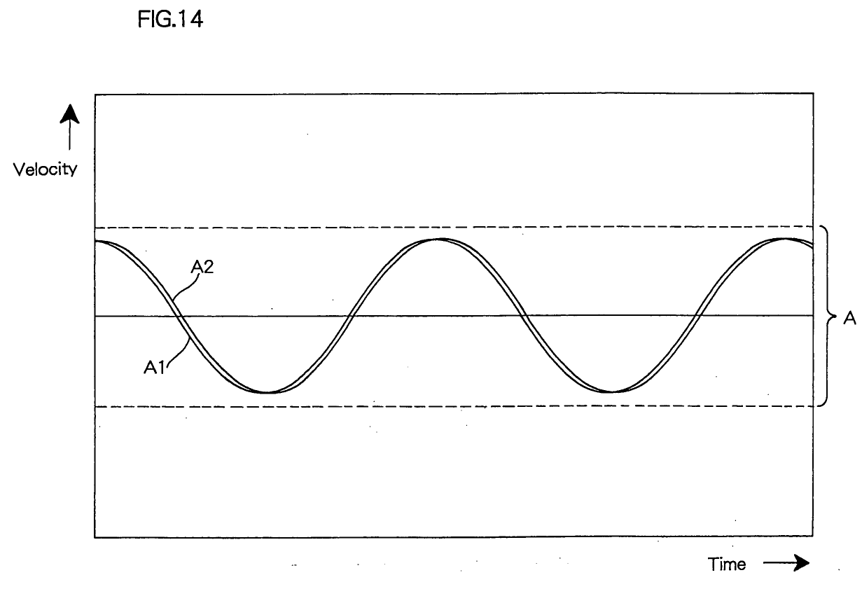

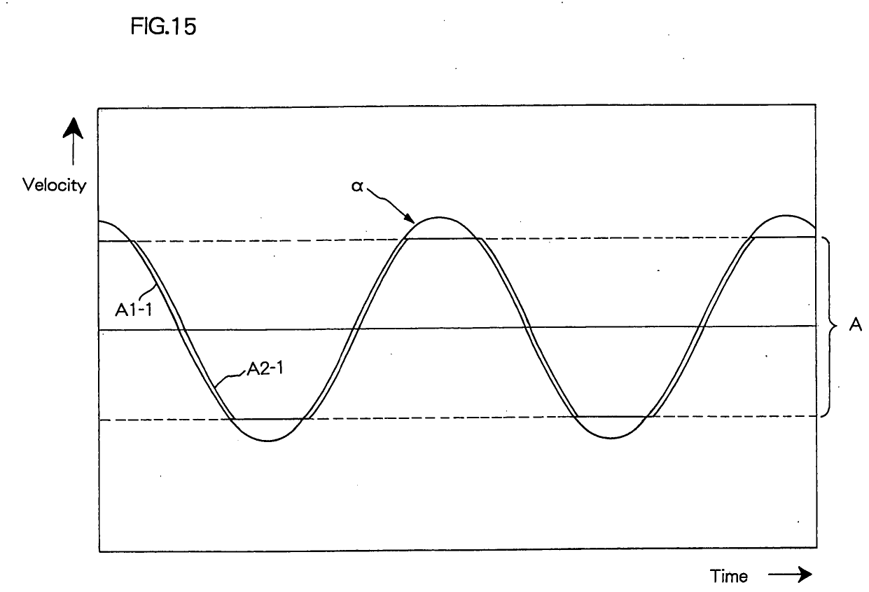

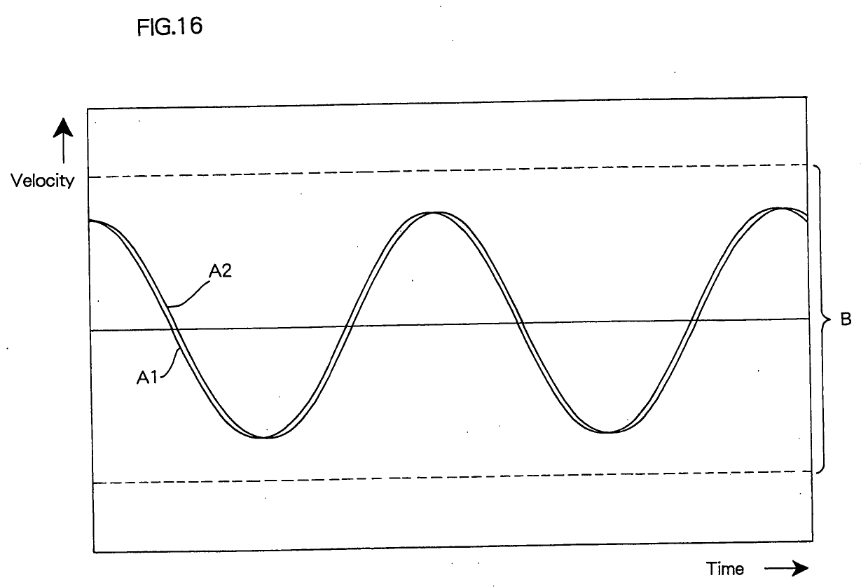

FIGS. 14 to 16 correspond to FIGS. 11 to 13, respectively. However, they are different in that FIGS. 11 to 13 explain the improvement in the compensation effect with respect to the camera shake amount (relative image movement distance) and FIGS. 14 to 17 explain the improvement in the compensation effect with respect to the camera shake speed (relative image movement speed). Concrete readings of the graphs are the same as those of the cases of FIGS. 11 to 13.

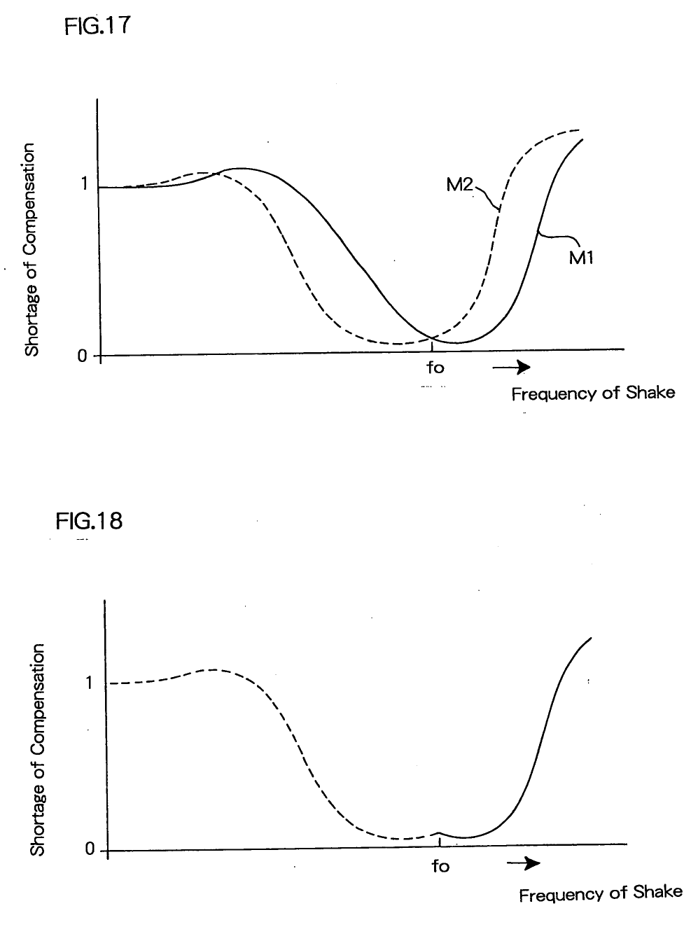

FIGS. 17 and 18 show graphs explaining advantages associated with compensation characteristics when shake compensation is made by use of two shake compensation systems. In these graphs, the vertical axis represents the “amount left uncompensated (shortage of compensation amount)” and the lateral axis represents the “camera shake frequency.”

That the “amount left uncompensated” is “zero” on the longitudinal axis means a condition where the camera shake is completely compensated for. That the “amount left uncompensated” is “1” means a condition where the camera shake is not compensated for at all (for example, when the shake compensation mechanism is off).

In FIG. 17, the solid line M1 represents the compensation characteristic of the shake compensation mechanism 32 of the camera body 10, and the broken line M2 represents the compensation characteristic of the shake compensation mechanism 26 of the interchangeable lens 20. The compensation characteristics of these shake compensation mechanisms are different from each other, and it is found that when the camera shake frequency is lower than f0, the shake compensation mechanism 26 (broken line M2) of the interchangeable lens 20 is more suitable and when the camera shake frequency is higher than f0, the shake compensation mechanism 32 (solid line M1) of the camera body 10 is more suitable.

By selectively using the two shake compensation systems according to the situation, an excellent shake compensation characteristic can be obtained in a wider frequency range as shown in FIG. 18.

In the camera body of the above-described structure, when a shake compensation mechanism is provided in the interchangeable lens, both or one of the “shake compensation system (mechanism) of the interchangeable lens” and the “shake compensation system (mechanism or digital system) of the camera body” can be selectively used according to the situation.

Therefore, because when the camera shake amount to be compensated for such as the movement amount or the movement speed is large, this is compensated for by use of two shake compensation systems, a comparatively compact one is good enough as each shake compensation system. As a result, a high shake compensation function can be realized without the interchangeable lens barrel and the camera body being unnecessarily increased in size.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A camera body to which one of a plurality of interchangeable lenses is selectively attachable, the camera body comprising:
a shake detector;
a shake compensator; and
a controller that compensates for a camera shake by driving the shake compensator based on an output from the shake detector,
wherein the controller comprises:
a detector that communicates with the attached interchangeable lens and determines whether the interchangeable lens itself has a shake compensator or not; and
a selector that selects, when the detector determines that the interchangeable lens has a shake compensator, both or one of the shake compensator of the camera body and the shake compensator of the interchangeable lens according to a predetermined condition as a compensator to be used for camera shake compensation.

2. A camera body according to claim 1,
wherein the selector obtains an amount to be compensated for based on the output from the shake detector, the selector selecting one of the shake compensators of the interchangeable lens and the camera body when the amount to be compensated for is compensatable by only one of the shake compensators, and additionally selecting the other shake compensator when the amount to be compensated for exceeds an amount that is compensatable by the selected one of the shake compensators.

3. A camera body according to claim 1,
wherein the selector obtains a necessary compensation speed based on the output from the shake detector, the selector selecting one of the shake compensators of the interchangeable lens and the camera body when the compensation speed is compensatable by only one of the shake compensators, and additionally selecting the other shake compensator when the compensation speed exceeds a speed that is compensatable by the selected one of the shake compensators.

4. A camera body according to claim 1,
wherein the shake detector individually detects a camera shake in a horizontal direction and a camera shake in a vertical direction, and
wherein the selector selects one of the shake compensators of the interchangeable lens and the camera body as a shake compensator to be used for compensation of one of the camera shakes in the vertical and horizontal directions, and selects the other of the shake compensators as a shake compensator to be used for compensation of the other of the camera shakes.

5. A camera body according to claim 4 further comprising:
a position detector that detects a position of the camera body itself,
wherein the selector selects the shake compensator of the camera body as a shake compensator to be used for compensation of the camera shake in the horizontal direction based on an output from the position detector.

6. A camera body according to claim 1,
wherein the shake detector individually detects a camera shake of a high-frequency component and a camera shake of a low-frequency component, and
wherein the selector selects one of the shake compensators of the interchangeable lens and the camera body as a shake compensator to be used for compensation of one of the high-frequency component and the low-frequency component, and selects the other of the shake compensators as a shake compensator to be used for compensation of the other of the components.

7. A camera system comprising:
a plurality of interchangeable lenses including at least one interchangeable lens having a shake compensator; and
a camera body to which one of the plurality of interchangeable lenses is selectively attachable,
wherein the camera body comprising:
a shake detector;
a shake compensator; and
a controller that compensates for a camera shake by driving the shake compensator based on an output from the shake detector,
and wherein the controller comprises:
a detector that communicates with the attached interchangeable lens and determines whether the interchangeable lens itself has the shake compensator or not; and
a selector that selects, when the detector determines that the interchangeable lens has a shake compensator, both or one of the shake compensator of the camera body and the shake compensator of the interchangeable lens according to a predetermined condition as a compensator to be used for camera shake compensation.

8. A camera system according to claim 7,
wherein the selector obtains an amount to be compensated for based on the output from the shake detector, the selector selecting one of the shake compensators of the interchangeable lens and the camera body when the amount to be compensated for is compensatable by only one of the shake compensators, and additionally selecting the other shake compensator when the amount to be compensated for exceeds an amount that is compensatable by the selected one of the shake compensators.

9. A camera system according to claim 7,
wherein the selector obtains a necessary compensation speed based on the output from the shake detector, the selector selecting one of the shake compensators of the interchangeable lens and the camera body when the compensation speed is compensatable by only one of the shake compensators, and additionally selecting the other shake compensator when the compensation speed exceeds a speed that is compensatable by the selected one of the shake compensators.

10. A camera system according to claim 7,
wherein the shake detector individually detects a camera shake in a horizontal direction and a camera shake in a vertical direction, and
wherein the selector selects one of the shake compensators of the interchangeable lens and the camera body as a shake compensator to be used for compensation of one of the camera shakes in the vertical and horizontal directions, and selects the other of the shake compensators as a shake compensator to be used for compensation of the other of the camera shakes.

11. A camera system according to claim 10 further comprising:
a position detector that detects a position of the camera body itself,
wherein the selector selects the shake compensator of the camera body as a shake compensator to be used for compensation of the camera shake in the horizontal direction based on an output from the position detector.

12. A camera system according to claim 7,
wherein the shake detector individually detects a camera shake of a high-frequency component and a camera shake of a low-frequency component, and
wherein the selector selects one of the shake compensators of the interchangeable lens and the camera body as a shake compensator to be used for compensation of one of the high-frequency component and the low-frequency component, and selects the other of the shake compensators as a shake compensator to be used for compensation of the other of the components.
